(19) United States
(12) Patent Application Publication
(10) Pub. No.: US 2016/0264819 A1
(43) Pub. Date: Sep. 15, 2016

(54) SLOT EXTRUSION COATING METHODS FOR PRODUCING POLYIMIDE-BASED FILMS

(71) Applicant: SAMSUNG ELECTRONICS CO., LTD., Suwon-si (KR)

(72) Inventors: Sang Soo JEE, Hwaseong-si (KR); Min Sang KIM, Anseong-si (KR); Hyunjeong JEON, Seoul (KR); Hongkyoon CHOI, Seoul (KR); Byunghee SOHN, Yongin-si (KR)

(21) Appl. No.: 15/056,273

(22) Filed: Feb. 29, 2016

(30) Foreign Application Priority Data
Mar. 11, 2015 (KR) 10-2015-0033990

(51) Int. Cl. C09D 179/08; B05D 1/26

(52) U.S. Cl. CPC C09D 179/08; B05D 1/265

(57) ABSTRACT

A slot extrusion coating method includes: preparing a composition including a condensation polymerization product of a diamine and a mixture of an acid dianhydride or an acid dianhydride and a reactive carbonyl compound, an imidized product thereof, or a mixture thereof, wherein the composition has a viscoelasticity having a tan δ of less than about 96 at a strain of about 1 percent and an angular frequency of more than about 0 to less than about 10 radians per second, and coating the composition on a substrate using a slit coater.

### CROSS REFERENCE TO RELATED APPLICATIONS

This application claims priority to and the benefit of Korean Patent Application No. 10-2015-0033990, filed in the Korean Intellectual Property Office on Mar. 11, 2015, and all the benefits accruing therefrom under 35 U.S.C. §119, the entire content of which is incorporated herein by reference.

### BACKGROUND

1. Field

A slot extrusion coating method for producing polyimide-based films is disclosed.

2. Description of the Related Art

A polyimide is a kind of high performance polymer, which includes a cyclic imide and an aromatic ring in a main chain. Because polyimides have desirable thermal stability, mechanical, and optical properties, they draw a lot of attention in advanced technology fields such as microelectronics, aviation, and separation technologies. A polyimide-based film including a polyimide or a precursor thereof may be obtained by preparing a film using a polymer solution including a polyimide and/or a polyamic acid and heat-treating the same, if desired. The film may be subjected to an additional heat treatment, if desired. The film may be produced in a uniform and continuous layer on a predetermined substrate according to the various coating methods (e.g., spin coating, slot extrusion coating).

The spin coating method produces a film by depositing a coating composition including a polyamic acid or the like on a substrate and spinning the substrate. In the spin coating method, it is difficult to control a film thickness, there is a coating liquid loss during the spinning process, and it produces inherent defects such as an edge bead, and the like. Accordingly, when a film having a precisely-controlled thickness is desired, a slot extrusion coating method is more preferable than the spin coating method.

The slot extrusion coating may accurately provide a predetermined amount of composition. The slot extrusion coating may form a thin sheet (e.g., film or coating) of a material on a substrate by feeding a fluid (coating or film composition) through a coating slit die and applying the same in a form of a sheet or film on the substrate. In slot extrusion coating, a slit (or slot) die coater may be used. By injecting the coating composition into a die slit of a coater and pressing the same while moving the die, the predetermined amount of composition is discharged through the slit having a predetermined width and coated on the substrate surface. The defects occurring while forming a film on the substrate according to the slot extrusion coating are seriously undesirable.

### SUMMARY

An embodiment provides a method of producing a polyimide-based film having a reduced number of defects by adjusting a viscoelasticity of a polymer composition during slot extrusion coating.

Another embodiment provides a polyimide-based film produced from the method.

According to an embodiment, the slot extrusion coating method includes:

preparing a composition having viscosity recommended for the slit coater at room temperature and including a condensation polymerization product of a diamine and an acid dianhydride or of a diamine and a mixture of an acid dianhydride and a reactive carbonyl compound, an imidized product thereof, or a mixture thereof, wherein the composition has a viscoelasticity having a tan δ of less than about 96 at a strain of about 1 percent and an angular frequency of more than about 0 to less than about 10 radians per second; and

coating the composition on a substrate with a slit coater.

The substrate may include a polymer, a metal oxide, a metal nitride, an organic/inorganic hybrid material, or a combination thereof.

The acid dianhydride may be represented by Chemical Formula 1:

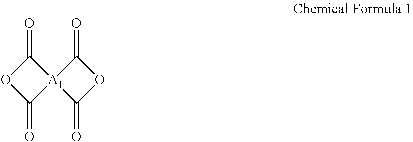

wherein A₁ is a substituted or unsubstituted tetravalent C6 to C24 aliphatic cyclic group, a substituted or unsubstituted tetravalent C6 to C24 aromatic cyclic group, or a substituted or unsubstituted tetravalent C4 to C24 hetero aromatic cyclic group, wherein the aliphatic cyclic group, the aromatic cyclic group, or the hetero aromatic cyclic group is present singularly, or two or more rings are fused to each other to provide a condensed ring; or two or more rings are linked through a direct bond, —O—, —S—, —C(═O)—, —CH(OH)—, —S(═O)₂—, —Si(CH₃)₂—, —(CH₂)ₚ— wherein 1≦p≦10, —(CF₂)_{q}— wherein 1≦q≦10, —CR₂— wherein each R is independently hydrogen, a C1 to C10 aliphatic hydrocarbon group, a C6 to C20 aromatic hydrocarbon group, or a C6 to C20 alicyclic hydrocarbon group, —C(CF₃)₂—, —C(CF₃)(C₆H₅)—, or —C(═O)NH—.

The diamine may be represented by Chemical Formula 2:

NH₂-A₂-NH₂ Chemical Formula 2

wherein A₂ is a substituted or unsubstituted divalent C6 to C24 aliphatic cyclic group, a substituted or unsubstituted divalent C6 to C24 aromatic cyclic group, or a substituted or unsubstituted divalent C4 to C24 hetero aromatic cyclic group, wherein the aliphatic cyclic group, the aromatic cyclic group, or the hetero aromatic cyclic group is present singularly, or two or more rings are fused to each other to provide a condensed ring; or two or more rings are linked through a direct bond, —O—, —S—, —C(═O)—, —CH(OH)—, —S(═O)₂—, —Si(CH₃)₂—, —(CH₂)ₚ— wherein 1≦p≦10, —(CF₂)_{q}— wherein 1≦q≦10, —CR₂— wherein each R is independently hydrogen, a C1 to C10 aliphatic hydrocarbon group, a C6 to C20 aromatic hydrocarbon group, or a C6 to C20 alicyclic hydrocarbon group, —C(CF₃)₂—, —C(CF₃)(C₆H₅)—, or —C(═O)NH—.

The reactive carbonyl compound may be represented by Chemical Formula 3:

X—CO-A₃-CO—X Chemical Formula 3

wherein A₃ is a substituted or unsubstituted divalent phenylene moiety, a substituted or unsubstituted divalent naphthalene moiety, or a moiety where two substituted or unsubstituted aromatic rings are linked through a single bond, —O—, —S—, —C(═O)—, —SO₂—, —Si(CH₃)₂—, —(CR₂)ₚ— wherein 1≦p≦10, each R is independently hydrogen, a hydroxyl group, a C1 to C3 alkyl group, a C1 to C3 fluoroalkyl group, or (CF₂)_{q} wherein 1≦q≦10, and X is —Cl, —OH, or —OCH₃.

The composition may further include a viscoelasticity-controlling agent.

The viscosity of the composition may be greater than or equal to about 1000 centipoise (cps) and less than or equal to about 20,000 cps at room temperature, e.g., about 25° C.

The adjusting the viscoelasticity of the composition may include adjusting a solid content of the composition, a molecular weight, a polydispersity index, a content of the condensation polymerization product or the imidized product thereof, a kind of viscoelasticity-controlling agent, a content of a viscoelasticity-controlling agent, or a combination thereof.

The viscoelasticity of the composition may be controlled so that the composition has a value of tan δ of less than or equal to about 90 as measured by a rheometer at a strain of 1 percent (%) and an angular frequency of greater than about 0 and less than or equal to about 10 radians per second (rad/s), e.g., from about 2 to about 10.

The viscoelasticity of the composition may be controlled so that the composition has a tan δ of less than or equal to about 75 as measured by a rheometer at a strain of 1% and an angular frequency of greater than about 0 and less than or equal to about 10 rad/s, e.g., greater than or equal to about 2 to less than or equal to about 10 rad/s.

According to these embodiments, the viscosity and the viscoelasticity of a polyimide composition or a precursor composition thereof for a slot extrusion coating are controlled to suppress occurrence of defects, and thus a polyimide based film having a precisely controlled size and enhanced quality may be prepared, for example, at a relatively high productivity. The films thus prepared may be used in various electronic devices such as an OLED.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, advantages and features of this disclosure will become more apparent by describing in further detail exemplary embodiments thereof with reference to the accompanying drawings, in which:

FIG. 1 is a view schematically showing an embodiment of a slot extrusion coating;

FIG. 2 is a view schematically showing the types of defects which may occur in the slot extrusion coating;

FIG. 3 is a view schematically illustrating an embodiment of a drop formation phenomenon that causes defects in the slot extrusion coating.

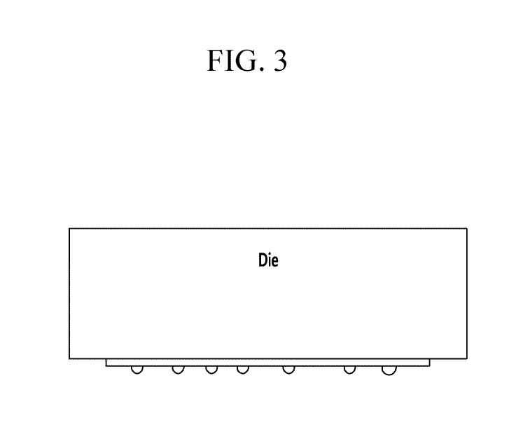

FIG. 4 is a graph of tan δ versus angular frequency (inverse seconds, 1/s) showing the results of dynamic mechanical analysis (DMA) of the compositions according to Examples 1 to 2 and Comparative Examples 1 to 4;

FIG. 5 is a photograph of a coating lip when a pressure is removed in the slot extrusion coating of the composition according to Example 2; and

FIG. 6 is a photograph of a coating lip when a pressure is removed in the slot extrusion coating of the composition according to Comparative Example 2.

### DETAILED DESCRIPTION

Hereinafter, embodiments are described in further detail. However, these embodiments are exemplary, and this disclosure is not limited thereto. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, when specific definition is not otherwise provided, the term “substituted” refers to one substituted with at least one substituent selected from a halogen (—F, —Cl, —Br, or —I), a hydroxyl group, a nitro group, a cyano group, an amino group, an amidino group, a hydrazine group, a hydrazone group, a carboxyl group, an ester group, a ketone group, a substituted or unsubstituted alkyl group, a substituted or unsubstituted alicyclic organic group, a substituted or unsubstituted aryl group, a substituted or unsubstituted alkenyl group, a substituted or unsubstituted alkynyl group, a substituted or unsubstituted heteroaryl group, and a substituted or unsubstituted heterocyclic group instead of at least one hydrogen of the given functional group, and the substituents may be linked to each other to provide a ring.

“Aliphatic group” means a saturated or unsaturated linear or branched hydrocarbon group. An aliphatic group may be an alkyl, alkenyl, or alkynyl group, for example.

“Aromatic” means a hydrocarbon having an aromatic ring, and includes monocyclic and polycyclic hydrocarbons wherein the additional ring(s) of the polycyclic hydrocarbon may be aromatic or nonaromatic. Specific aromatic compounds include benzene, naphthalene, toluene, and xylene.

As used herein, when specific definition is not otherwise provided, the term “alkyl group” refers to a C1 to C30 alkyl group, and the term “aryl group” refers to a C6 to C30 aryl group.

As used herein, the term “heterocyclic group” refers to a cyclic group including 1 to 3 hetero atoms selected from O, S, N, P, Si, and a combination thereof in one ring, and may include for example, pyridine, thiophene, pyrazine, and the like, but is not limited thereto.

As used herein, “polyimide-based film” refers to a film including a polyimide or a precursor thereof (e.g., a polyamic acid or a copolymer thereof).

As used herein, the term “slot” and “slit” have substantially the same meaning.

As used herein, the term “metal” includes a metal and a semi-metal.

As used herein, a viscoelasticity-controlling agent is a material being capable of increasing or decreasing viscosity, elasticity, or a combination thereof of a polyimide or a precursor composition.

In one embodiment, a slot extrusion coating method includes:

obtaining a substrate;

obtaining a slit coater;

preparing a composition having viscosity recommended for the slit coater at room temperature and including a condensation polymerization product of a diamine and an acid dianhydride or of a diamine and a mixture of an acid dianhydride and a reactive carbonyl compound, an imidized product thereof, or a mixture thereof; and

coating the composition on the substrate using the slit coater,

wherein the preparing a composition includes adjusting viscoelasticity of the composition to provide tan δ of the composition with a maximum value of less than about 96 at a strain of about 1% and an angular frequency of greater than about 0 and less than or equal to about 10 rad/s (e.g., tan δ of the composition at angle frequency of greater than about 1 and less than or equal to about 10, or an angle frequency of about 2 to about 10 rad/s, or an angle frequency of about 2.2 to about 4 rad/s).

The material for the substrate is not particularly limited, but may be appropriately selected as desired. For non-limiting examples, the substrate may include a polymer, glass, a metal oxide such as silica, a metal nitride such as SiN, an organic/inorganic hybrid material, or a combination thereof. The size and the thickness of the substrate are not particularly limited, and may be appropriately selected considering the size of a slit coater to be used. The substrate may have the smooth surface and does not have a form of a web. The substrate having a desired material and size may be commercially available or prepared by methods known to one of skill in the art and without undue experimentation.

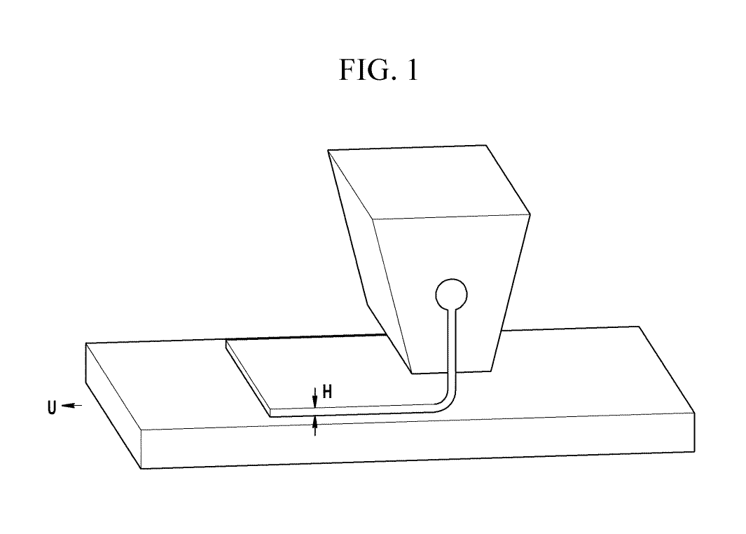

The slit coater is a coating system including a die (hereinafter referred to as a slot die) having a slot-shaped coating lip (i.e., a part for discharging a coating composition), and a non-limiting and schematic structure of the slot die is shown in FIG. 1. The coating system has been produced by various manufacturers (e.g., Toray Engineering, Co., Ltd., nTact Co., Ltd., or the like), and the details for the coating system such as constituent elements, a shape, a material of the slot die, pressing members such as pneumatic or hydraulic pressure chamber, or the like, have been disclosed and are commercially available. For example, the coating lip is the part for discharging the coating solution and includes a slot having a width of less than or equal to about 10 millimeters (mm), for example, less than or equal to about 5 mm, from about 0.5 mm to about 5 mm, from about 0.5 mm to about 3 mm, or less than or equal to about 1 mm. In order to prepare a uniform film having a desirable thickness on a substrate using the slit coater, a capillary tube gap in the coating lip, a slit moving speed, a clearance gap (i.e., distance from the substrate to the coating lip), a discharging amount of the coating composition per unit time, and viscosity of the composition may be adjusted. In the slit coater, the slot die may form a film on the substrate by discharging the coating composition (e.g., by using pressure, i.e., by extrusion) while moving the substrate or while moving on the substrate, and thus the coating composition may be desirably have a viscosity within a selected range in order for the slot die to form a uniform film having a desirable thickness with high precision.

In an embodiment, the coating composition includes a condensation polymerization product (e.g., a polyamic acid or a copolymer thereof) of a diamine and an acid dianhydride or of a diamine and a mixture of or an acid dianhydride and a reactive carbonyl compound, an imidized product thereof, or a mixture thereof, and has viscosity recommended for the slit coater at room temperature.

The acid dianhydride may be represented by Chemical Formula 1:

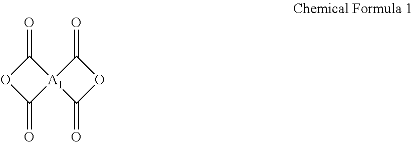

wherein A₁ is a substituted or unsubstituted tetravalent C6 to C24 aliphatic cyclic group, a substituted or unsubstituted tetravalent C6 to C24 aromatic cyclic group, or a substituted or unsubstituted tetravalent C4 to C24 hetero aromatic cyclic group, wherein the aliphatic cyclic group, the aromatic cyclic group, or the hetero aromatic cyclic group is present singularly, or two or more rings are fused to each other to provide a condensed ring; or two or more rings are linked through a direct bond, —O—, —S—, —O(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein R is independently hydrogen, a C1 to C10 aliphatic hydrocarbon group, a C6 to C20 aromatic hydrocarbon group, or a C6 to C20 alicyclic hydrocarbon group), —C(CF₃)₂—,
—C(CF₃)(C₆H₅)—, or —C(═O)NH—.

For non-limiting examples, in Chemical Formula 1, A₁ may be selected from the following.

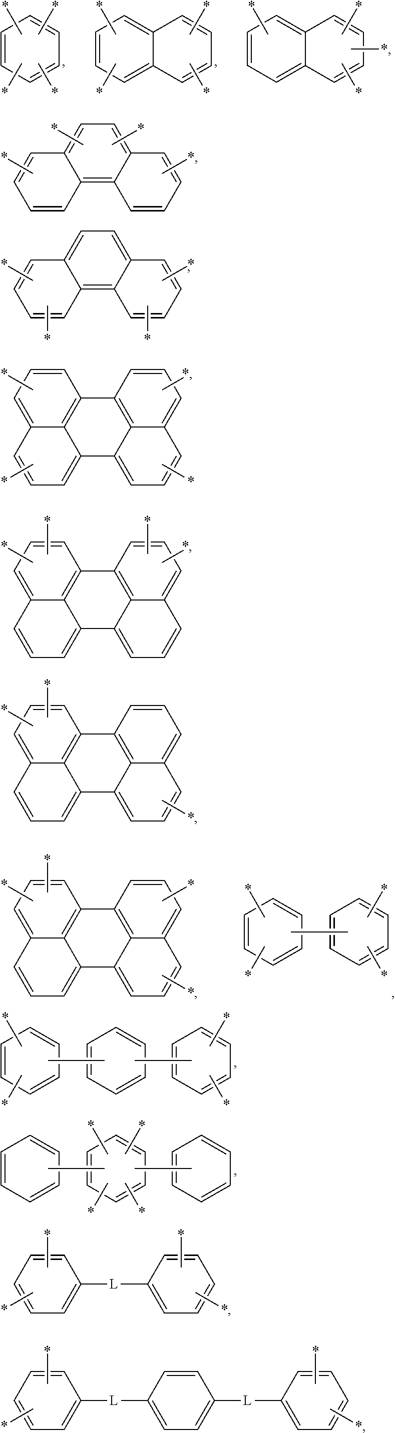

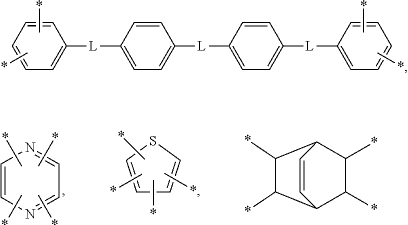

In the chemical formulae, the aromatic ring moiety may be substituted or unsubstituted, each L is the same as or different from each other, and is independently a direct bond, —O—, —S—, —O(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein each R is independently hydrogen, a C1 to C10 aliphatic hydrocarbon group, a C6 to C20 aromatic hydrocarbon group, or a C6 to C20 alicyclic hydrocarbon group), —C(CF₃)₂—, —C(CF₃)(C₆H₅)—, or —C(═O)NH—, and * is a point where they are linked to a carbon of the carbonyl group,

For non-limiting examples, the acid dianhydride may be one or more selected from 3,3′,4,4′-biphenyl tetracarboxylic dianhydride (BPDA), bicyclo[2.2.2]oct-7-ene-2,3,5,6-tetracarboxylic dianhydride (BTDA), 3,3′,4,4′-diphenylsulfone tetracarboxylic dianhydride (DSDA), 4,4′-(hexafluoroisopropylidene)diphthalic anhydride (6FDA), 4,4′-oxydiphthalic anhydride (ODPA), pyromellitic dianhydride (PMDA), 4-(2,5-dioxotetrahydrofuran-3-yl)-1,2,3,4-tetrahydronaphthalene-1,2-dicarboxylic anhydride (DTDA), 1,2,4,5-benzene tetracarboxylic dianhydride; 1,2,3,4-benzene tetracarboxylic dianhydride; 1,4-bis(2,3-dicarboxyphenoxy) benzene dianhydride; 1,3-bis(3,4-dicarboxyphenoxy) benzene dianhydride; 1,2,4,5-naphthalene tetracarboxylic dianhydride; 1,2,5,6-naphthalene tetracarboxylic dianhydride; 1,4,5,8-naphthalene tetracarboxylic dianhydride; 2,3,6,7-naphthalene tetracarboxylic dianhydride; 2,6-dichloronaphthalene-1,4,5,8-tetracarboxylic dianhydride; 2,7-dichloronaphthalene-1,4,5,8-tetracarboxylic dianhydride; 2,3,6,7-tetrachloronaphthalene-1,4,5,8-tetracarboxylic dianhydride; 2,2′,3,3′-diphenyl tetracarboxylic dianhydride; 4,4′-bis(3,4-dicarboxyphenoxy)diphenyl dianhydride; bis(2,3-dicarboxylphenyl) ether dianhydride; 4,4′-bis(2,3-dicarboxyphenoxy) diphenylether dianhydride; 4,4′-bis(3,4-dicarboxyphenoxy) diphenylether dianhydride; bis(3,4-dicarboxylphenyl) sulfide dianhydride; 4,4′-bis(2,3-dicarboxyphenoxy) diphenyl sulfide dianhydride; 4,4′-bis(3,4-dicarboxyphenoxy) diphenyl sulfide dianhydride; bis(3,4-dicarboxylphenyl) sulfone dianhydride; 4,4′-bis(2,3-dicarboxyphenoxy) diphenylsulfone dianhydride; 4,4′-bis(3,4-dicarboxylphenoxy) diphenylsulfone dianhydride; 3,3′,4,4′-benzophenone tetracarboxylic dianhydride; 2,2′,3,3′-benzophenone tetracarboxylic dianhydride; 2,3,3′4′-benzophenone tetracarboxylic dianhydride; 4,4′-bis(3,4-dicarboxylphenoxy) benzophenone dianhydride; bis(2,3-dicarboxylphenyl) methane dianhydride; bis(3,4-dicarboxylphenyl) methane dianhydride; 1,1-bis(2,3-dicarboxylphenyl) ethane dianhydride; 1,1-bis(3,4-dicarboxylphenyl) ethane dianhydride; 1,2-bis(3,4-dicarboxylphenyl) ethane dianhydride; 2,2-bis(2,3-dicarboxylphenyl) propane dianhydride; 2,2-bis(3,4-dicarboxylphenyl) propane dianhydride; 2,2-bis[4-(2,3-dicarboxyphenoxy) phenyl] propane dianhydride; 2,2-bis[4-(3,4-dicarboxylphenoxy) phenyl] propane dianhydride; 4-(2,3-dicarboxylphenoxy)-4′-(3,4-dicarboxylphenoxy) diphenyl-2,2-propane dianhydride; 2,2-bis[4-(3,4-dicarboxylphenoxy-3,5-dimethyl) phenyl] propane dianhydride; 2,3,4,5-thiophene tetracarboxylic dianhydride; 2,3,5,6-pyrazine tetracarboxylic dianhydride; 1,8,9,10-phenanthrene tetracarboxylic dianhydride; 3,4,9,10-perylene tetracarboxylic dianhydride; 1,3-bis(3,4-dicarboxylphenyl) hexafluoropropane dianhydride; 1,1-bis(3,4-dicarboxylphenyl)-1-phenyl-2,2,2-trifluoroethane dianhydride; 2,2-bis[4-(3,4-dicarboxylphenoxy) phenyl] hexafluoropropane dianhydride; 1,1-bis[4-(3,4-dicarboxylphenoxy) phenyl]-1-phenyl-2,2,2-trifluoro ethane dianhydride; and 4,4′-bis[2-(3,4-dicarboxylphenyl)hexafluoroisopropyl] diphenyl ether dianhydride.

The diamine may be represented by Chemical Formula 2:

NH₂-A₂-NH₂ Chemical Formula 2

wherein A₂ is a substituted or unsubstituted divalent C6 to C24 aliphatic cyclic group, a substituted or unsubstituted divalent C6 to C24 aromatic cyclic group or a substituted or unsubstituted divalent C4 to C24 heteroaromatic cyclic group, wherein the aliphatic cyclic group, the aromatic cyclic group, or the heteroaromatic cyclic group is present singularly, or two or more rings are fused to each other to provide a condensed ring; or two or more rings are linked through a direct bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein each R is independently hydrogen, a C1 to C10 aliphatic hydrocarbon group, a C6 to C20 aromatic hydrocarbon group, or a C6 to C20 alicyclic hydrocarbon group), —C(CF₃)₂—, —C(CF₃)(C₆H₅)—, or —C(═O)NH—.

In Chemical Formula 2, A₂ may be selected from the following.

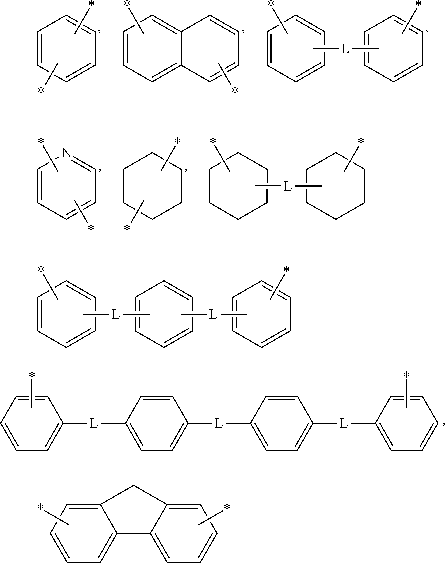

In the chemical formulae, the aromatic or alicyclic ring may be substituted or unsubstituted, each L is the same as or different from each other, and is independently a direct bond, —O—, —S—, —C(═O)—, —CH(OH)—, —S(═O)₂—, —Si(CH₃)₂—, —(CH₂)ₚ— (wherein 1≦p≦10), —(CF₂)_{q}— (wherein 1≦q≦10), —CR₂— (wherein each R is independently hydrogen, a C1 to C10 aliphatic hydrocarbon group, a C6 to C20 aromatic hydrocarbon group, or a C6 to C20 alicyclic hydrocarbon group), —C(CF₃)₂—, —C(CF₃)(C₆H₅)—, or —C(═O)NH—, and * is a point where they are linked to nitrogen of the amine group.

For non-limiting examples, A₂ may be selected from the following.

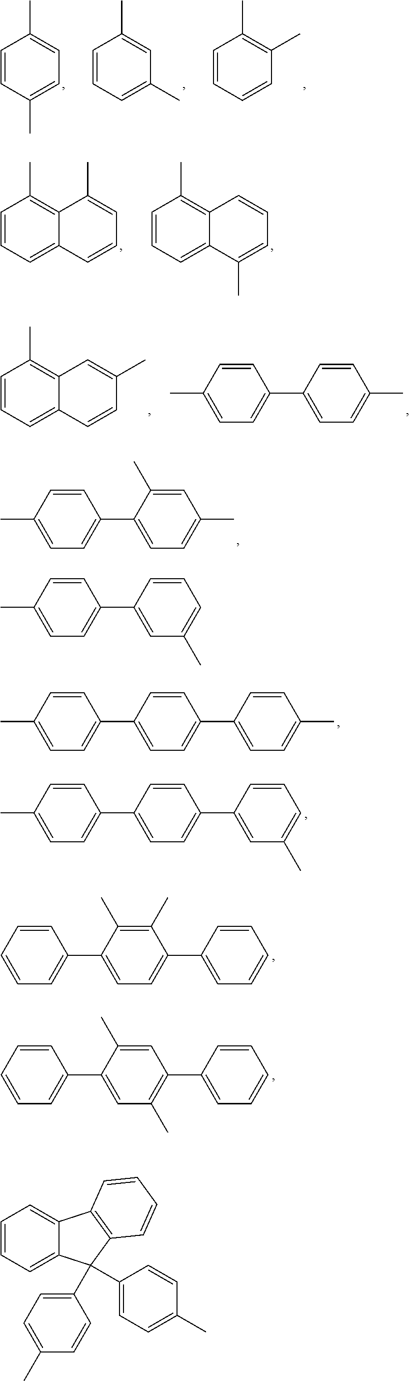

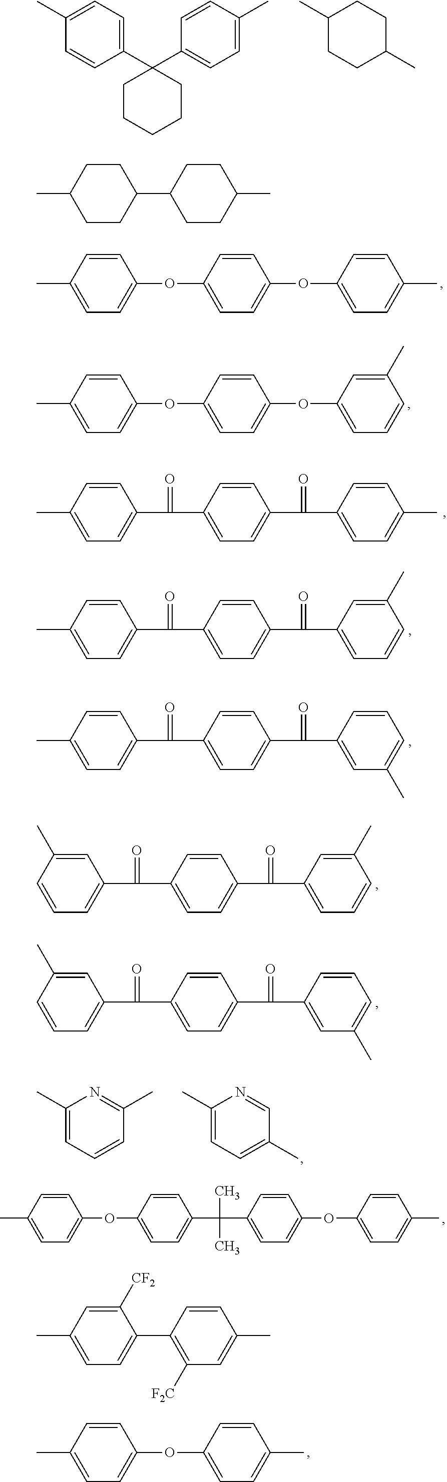

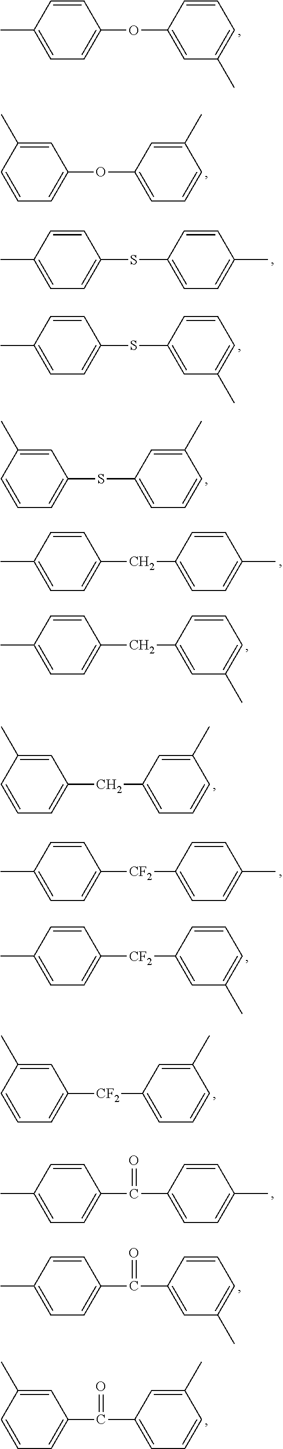

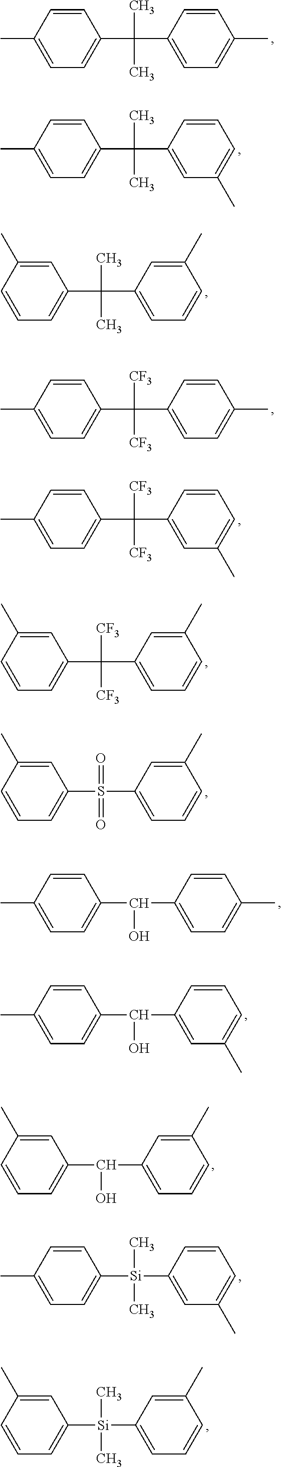

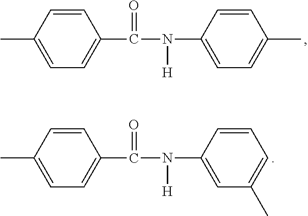

For non-limiting examples, the diamine may be selected from m-phenylene diamine; p-phenylene diamine; 1,3-bis(4-aminophenyl) propane; 2,2-bis(4-aminophenyl) propane; 4,4′-diamino-diphenyl methane; 1,2-bis(4-aminophenyl) ethane; 1,1-bis(4-aminophenyl) ethane; 2,2′-diamino-diethyl sulfide; bis(4-aminophenyl) sulfide; 2,4′-diamino-diphenyl sulfide; bis(3-aminophenyl) sulfone; bis(4-aminophenyl) sulfone; 4,4′-diamino-dibenzyl sulfoxide; bis(4-aminophenyl) ether; bis(3-aminophenyl) ether; bis(4-aminophenyl)diethyl silane; bis(4-aminophenyl) diphenyl silane; bis(4-aminophenyl) ethyl phosphine oxide; bis(4-aminophenyl) phenyl phosphine oxide; bis(4-aminophenyl)-N-phenyl amine; bis(4-aminophenyl)-N-methylamine; 1,2-diamino-naphthalene; 1,4-diamino-naphthalene; 1,5-diamino-naphthalene; 1,6-diamino-naphthalene; 1,7-diamino-naphthalene; 1,8-diamino-naphthalene; 2,3-diamino-naphthalene; 2,6-diamino-naphthalene; 1,4-diamino-2-methyl-naphthalene; 1,5-diamino-2-methyl-naphthalene; 1,3-diamino-2-phenyl-naphthalene; 4,4′-diamino-biphenyl; 3,3′-diamino-biphenyl; 3,3′-dichloro-4,4′-diamino-biphenyl; 3,3′-dimethyl-4,4′-diamino-biphenyl; 3,4′-dimethyl-4,4′-diamino-biphenyl; 3,3′-dimethoxy-4,4′-diamino-biphenyl; 4,4′-bis(4-aminophenoxy)-biphenyl; 2,4-diamino-toluene; 2,5-diamino-toluene; 2,6-diamino-toluene; 3,5-diamino-toluene; 1,3-diamino-2,5-dichloro-benzene; 1,4-diamino-2,5-dichloro-benzene; 1-methoxy-2,4-diamino-benzene; 1,4-diamino-2-methoxy-5-methyl-benzene; 1,4-diamino-2,3,5,6-tetramethyl-benzene; 1,4-bis(2-methyl-4-amino-pentyl)-benzene; 1,4-bis(1,1-dimethyl-5-amino-pentyl)-benzene; 1,4-bis(4-aminophenoxy)-benzene; o-xylylene diamine; m-xylylene diamine; p-xylylene diamine; 3,3′-diamino-benzophenone; 4,4′-diamino-benzophenone; 2,6-diamino-pyridine; 3,5-diamino-pyridine; 1,3-diamino-adamantane; bis[2-(3-aminophenyl)hexafluoroisopropyl] diphenyl ether; 3,3′-diamino-1,1,1′-diadamantane; N-(3-aminophenyl)-4-aminobenzamide; 4-aminophenyl-3-aminobenzoate; 2,2-bis(4-aminophenyl) hexafluoropropane; 2,2-bis(3-aminophenyl) hexafluoropropane; 2-(3-aminophenyl)-2-(4-aminophenyl)hexafluoropropane; 2,2-bis[4-(4-aminophenoxy)phenyl] hexafluoropropane; 2,2-bis[4-(2-chloro-4-aminophenoxy)phenyl hexafluoropropane; 1,1-bis(4-aminophenyl)-1-phenyl-2,2,2-trifluoroethane; 1,1-bis[4-(4-aminophenoxy)phenyl]-1-phenyl-2,2,2-trifluoroethane; 1,4-bis(3-aminophenyl) buta-1-en-3-yne; 1,3-bis(3-aminophenyl) hexafluoropropane; 1,5-bis(3-aminophenyl) decafluoropentane; and 4,4′-bis[2-(4-aminophenoxyphenyl) hexafluoroisopropyl] diphenyl ether, diaminocyclohexane, bicyclohexyldiamine, 4,4′-diaminocyclohexylmethane, and diaminofluorene.

The reactive carbonyl compound may be represented by Chemical Formula 3:

X—CO-A₃-CO—X Chemical Formula 3

wherein A₃ is a substituted or unsubstituted divalent phenylene moiety, a substituted or unsubstituted divalent naphthalene moiety, or a moiety where two substituted or unsubstituted aromatic rings are linked through a single bond, —O—, —S—, —C(═O)—, —SO₂—, —Si(CH₃)₂—, —(CR₂)ₚ— (wherein 1≦p≦10, each R is independently hydrogen, a hydroxyl group, a C1 to C3 alkyl group, a C1 to C3 fluoroalkyl group, or —(CF₂)_{q}— (wherein 1≦q≦10), and X is —Cl, —OH, or —OCH₃.

The reactive carbonyl compound may be terephthalic acid, dimethyl terephthalate, terephthaloyl chloride (TPCL), 4,4′-benzoyl chloride, 2,6-naphthalene dicarboxylic dichloride, 1,5-naphthalene dicarboxylic dichloride, or a combination thereof, but is not limited thereto.

The condensation polymerization product of the diamine and the acid dianhydride may be polyamic acid. The condensation polymerization product of the diamine and a mixture of the acid dianhydride and the reactive carbonyl compound may be poly(amic acid-amide). In the condensation polymerization product of the diamine and a mixture of the acid dianhydride or acid dianhydride and a reactive carbonyl compound, the amount of the acid dianhydride or the mixture of the acid dianhydride and the reactive carbonyl compound may be from about 0.9 to about 1.1 mole, or 0.95 to about 1.05 mole per 1 mole of the diamine compound, but it is not limited thereto.

In the mixture of the acid dianhydride and the reactive carbonyl compound, the amount of the reactive carbonyl compound may be from about 0.01 mole to about 1 mole, or about 0.1 mole to about 0.8 mole per 1 mole of the acid dianhydride, but is not limited thereto.

The condensation polymerization of the diamine and the mixture of the acid dianhydride or the acid dianhydride and the reactive carbonyl compound may be carried out by stirring a monomer composition at a predetermined temperature (e.g., a temperature of about 0° C. to about 100° C.), optionally under an inert gas atmosphere, but is not limited thereto. The conditions for producing the polyamic acid or the copolymer thereof (solvent, temperature, or the like) are not particularly limited, but may be appropriately selected.

The condensation polymerization product may be partially imidized, for example, via chemical imidization or thermal imidization, and the composition may include an imidized product of the condensation polymerization product. The (e.g. partially) imidized product of the polyamic acid or poly(amic acid-amide) thus obtained may include a polyimide or a poly(imide-amide) copolymer. Before or after the imidization, if desired, it may be dried at a predetermined temperature to remove a solvent. According to an embodiment, the imidization may undergo chemical imidization. According to an embodiment, the imidization may undergo thermal imidization. According to another embodiment, the imidization may be performed by thermal imidization and chemical imidization. The specific conditions of the chemical imidization are known in the art. For example, the chemical imidization may include treating a poly(amic acid-amide) copolymer with an agent such as an aliphatic carboxylic dianhydride and a tertiary amine, for example, at an ambient temperature. Examples of the agent for the chemical imidization may include acetic anhydride, pyridine, and triethylamine, or the like. In this case, the imidization degree may be changed according to the solubility of a polyimide in the imidization mixture. The chemical imidization product may be formed into a film with the obtained composition as it was. Alternatively, after the recovery of the polymer, the chemical imidization product can be dissolved in an appropriate solvent (e.g., including N-methyl pyrrolidone, dimethyl acetamide, gamma butyrolactone, monochlorobenzene, or the like), and then formed into a film.

The composition may further include a viscoelasticity-controlling agent. The viscoelasticity-controlling agent may be appropriately selected considering the final usage of the film. For example, the viscoelasticity-controlling agent may include various inorganic material additives (e.g., metal oxide particles such as silica), organic material additives (e.g., a dye, a pigment, and the like, or a colorant, a binder, a thickener, or the like), or precursors of the additives, but is not limited thereto.

The specific range may vary with the manufacturer of the slit coater, but for most of the currently available slit coaters the composition desirably has a viscosity of greater than or equal to about 1000 centipoise (cps) and less than or equal to about 13,000 cps to provide a film of a polyimide or a precursor thereof. In the slot extrusion coating method according to an embodiment, the viscoelasticity of the composition having the ranged viscosity is controlled to provide tan δ of less than about 96 at a strain of about 1%, and at an angular frequency of greater than about 0 radians per second (rad/s) and less than about 10 rad/s, greater than about 1 rad/s and less than about 10 rad/s, or about 2 to about 10 rad/s. For example, the viscoelasticity of composition may be controlled to provide a maximum tan δ of less than or equal to about 90 as measured by a rheometer at a strain of about 1% and an angular frequency of about 2.0 to about 10 rad/s (e.g., an angular frequency of about 2.2 to less than or equal to about 4 rad/s). For example, the viscoelasticity of the composition may be controlled to provide a maximum tan δ of less than or equal to about 75 when measured by a rheometer at a strain of 1% and an angular frequency of about 2 rad/s to about 10 rad/s (e.g., an angular frequency of about 2.2 rad/s to less than or equal to about 4 rad/s).

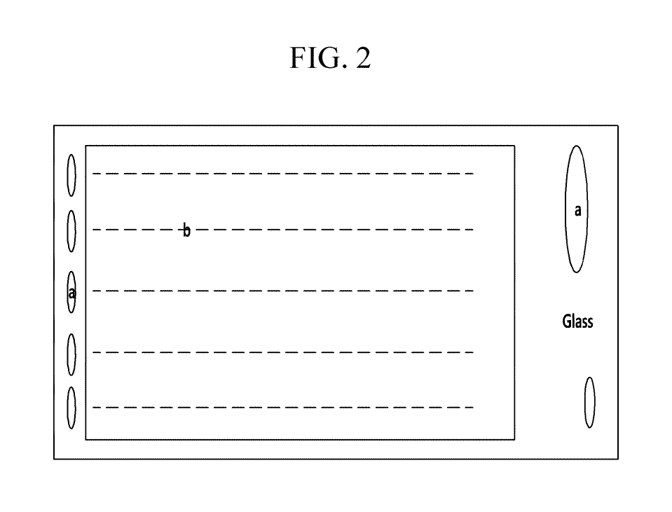

The slit coater discharges a predetermined amount of the coating composition through the thin slot thereof while moving the slot die, so the slit coater is desirably provided with a coating composition having a selected viscosity to allow the machine to produce a uniform film. However, the present inventors found that the obtained film may unavoidably have coating defects even when the composition has the desired viscosity. For example, as shown in FIG. 2, the coating composition may be stained at an undesirable place of the substrate. Thereby, the coating area may be changed and coating composition loss may occur, and furthermore, defects may be induced when an inorganic thin film (a barrier, a buffer layer, an amorphous silicone layer, etc.) is deposited on the coating film to provide a device (“a” in FIG. 2). In addition, a slit moving mark or vapor may be found on the obtained film, which may cause uniformity deterioration of the obtained film (“b” in FIG. 2).

The present inventors found that the film defects may be caused by composition drops forming in the coating lip of the slot die, and the drop forming phenomenon may be suppressed by controlling the viscoelasticity of the composition (i.e., tan δ at a low angle frequency). For example, when a first composition A and a second composition B having the same viscosity undergo slot extrusion coating under the same conditions, they may produce films with totally different quality depending upon tan δ of the composition under the low shear (in other words, at a strain of about 1% and an angular frequency of about 2 to about 10 rad/s, for example, an angular frequency of less than or equal to about 3 s⁻¹). For example, the first composition A having tan δ of greater than or equal to about 96 at a low shear may result in a significant number of solution drops formed on the edge of the slit; on the other hand, the second composition B having tan δ of less than about 96, for example, less than or equal to about 90, less than or equal to about 75, or less than or equal to about 54 at a low shear may result in substantially no solution drops formed on the edge of the slit. In addition, the present inventors found that the first composition A and the second composition B may have the similar value of the tan δ to each other at a high shear (i.e., at an angular speed of greater than or equal to about 10 rad/s, for example about 10 to about 1000 rad/s). In other words, according to the studies of the present inventors, tan δ measured outside the range of the shear conditions does not represent properties relating to the composition drop forming phenomenon.

Without being bound by any particular theory, the first composition A is predominantly viscous at a low shear, so the composition present in the coating lip droops even when shear force applied to the coating slot is removed. This may cause the drop forming phenomenon on the edge of the slit. The drop forming phenomenon caused by the composition drooping may cause defects in which the composition flows down and stains in an undesirable place during the arrangement and standby of the coater, and a drag mark may remain on the glass substrate surface when returning the coater. In addition, the first composition A may induce meniscus forming defects or the like, resulting in various shape defects in the final coating.

Without being bound by any particular theory, it is presumed that the drop forming phenomenon inducing defects occurs when adjusting the viscosity of the coating composition including a polyimide or a precursor thereof into the recommended viscosity range increases only the viscous property of the composition (particularly in a low shear). When adjusting the viscosity of the coating composition including a polyimide or a precursor thereof cause only the increase in the viscous property of coating composition at a low shear, tan thereof is increased. The tan δ refers to a ratio of a loss modulus (G″) indicating viscous components to a storage modulus (G′) indicating elastic components when the complex shear modulus G* is defined as follows.

In a Dynamic Viscoelastic Material Response, a complex shear modulus G* indicates a yardstick of total resistance of a material to transformation, and may be defined as follows.

G*=stress*/strain

The complex shear modulus G* may be represented as follows:

G*=G′+iG″

wherein G′ refers to a storage shear modulus and G″ refers to a loss shear modulus.

The storage modulus (G′) means properties of a material to store energy and may be defined by the equation:

G′=(stress*/strain)cos θ

wherein, in the equation, θ refers to a phase lag between stress and strain.

The loss modulus (G″) refers to properties of a material to disperse energy and may indicate energy lost by heat, which may be defined by the equation:

G″=(stress*/strain)sin θ

wherein, in the equation, θ is the same as defined above.

tan δ is defined as follows:

tan δ=G″/G′.

Accordingly, the higher tan δ is, the higher the relative ratio of loss (viscous) modulus (G″) to the storage (elastic) modulus (G′) is, which means that the viscous property of the material is increased. In other words, the lower tan δ is, the lower the relative ratio of the loss modulus (G″) to the storage modulus (G′) is, which means that the elastic property of the material is increased.

Without being bound by any particular theory, when the viscosity-adjusted coating composition has tan δ of greater than or equal to the predetermined level (e.g. about 96) under the predetermined ranged shear (in other words, showing decreased elasticity characteristics), the composition still tends to flow even if the shear force applied to the composition is eliminated by extrusion or pressure, and this tendency may lead to the drop forming phenomenon in the coating lip. On the other hand, the tan δ under the relatively high shear (e.g., of greater than or equal to about 10 rad/s) is not related to the properties relaxing the drop forming phenomenon in the coating lip.

Accordingly, in the extrusion coating method according to one embodiment, the coating composition has the viscosity recommended for the slit coater and simultaneously has a tan δ of less than about 95, for example, less than or equal to about 90, or less than or equal to about 75, at a strain of 1% and an angular frequency of greater than about 0 and less than about 10 rad/s (e.g., greater than or equal to about 2 rad/s and less than about 10 rad/s). When the composition satisfies the conditions, the composition drop forming phenomenon occurring in the coating lip is suppressed or prevented to provide a film having enhanced quality without the coating composition loss.

The controlling of the tan δ of the coating composition, as measured at an angular speed of greater than about 0 and less than about 10 rad/s (about 2 to about 10 rad/s, e.g., less than or equal to about 3 rad/s) at less than about 96 may be accomplished by adjusting a molecular structure, a molecular weight, a polydispersity index, a content of the condensation polymerization product or the imidized product thereof, a kind of additive, a content of additive, or a combination thereof. For example, not only the viscosity of the coating composition but also tan δ may be controlled within the desirable range by adjusting (e.g., increasing or decreasing) the solid content of the condensation polymerization product or the imidized product thereof in the coating composition. Additionally or alternatively, tan δ of the coating composition may be controlled to less than about 96, for example, less than or equal to about 90 or less than or equal to about 75, when measured at an angular speed of about 2 to about 10 rad/s (e.g., less than or equal to about 3 rad/s) while the coating composition has the recommended viscosity by adding an elastic property-dominant additive (e.g., polymer beads such as inorganic metal oxide particles).

When the coating composition has the recommended viscosity together with a tan δ measured at an angular speed of greater than about 0 and less than about 10 rad/s (e.g., greater than or equal to about 2 and less than about 10 rad/s, e.g., less than or equal to about 3 rad/s), the forming of the drops in the coating lip is effectively suppressed or prevented, and thus the chances of the defect-occurrence during the production of a film including a polyimide or a precursor thereof may be significantly decreased without delaying the coating speed. Accordingly, the method may achieve a high coating speed, for example, of a range of about 30 millimeters per second (mm/s) to about 100 mm/s.

The coated film may be further imidized by the heat treatment, if desired. The obtained polyimide film may be used as a substrate material of an organic LED or the like, but is not limited thereto.

Hereinafter, the present disclosure is illustrated in more detail with reference to examples. However, these examples are exemplary, and the present disclosure is not limited thereto.

### EXAMPLES

### Example 1

### [1] Preparation of Coating Composition Including Poly(Amic Acid)

Under a nitrogen atmosphere, N-methyl-2-pyrrolidone (NMP) is introduced into a reactor. 2,2′-bis-trifluoromethyl-4,4′-biphenyldiamine (TFDB) is added into the reactor and dissolved to provide a TFDB solution. 3,3′,4,4′-biphenyltetracarboxylic dianhydride (BPDA) and pyromellitic dianhydride (PMDA) are added at a ratio of 7 to 3 into the TFDB solution to provide a molar ratio of TFDB to the total molar number of the two compositions within about 0.96 to about 0.99. 2,2-bis(3-amino-4-hydroxyphenyl)-hexafluoropropane (bis-APAF) is added thereto at 0.1 mole % with respect to TFDB and the resulting mixture undergoes a reaction at 20° C. for 72 hours.

The polyamic acid solution thus obtained is measured for viscosity and added with an appropriate amount of NMP to meet an appropriate coating viscosity.

### [2] Measurement of Viscosity and Tan δ

The obtained coating compositions are measured for viscosity using a rheometer (manufactured by Anton Paar, Physica MCR 501 rheometer). From the results, it is confirmed that the composition has viscosity of 9820 centipoise (cps).

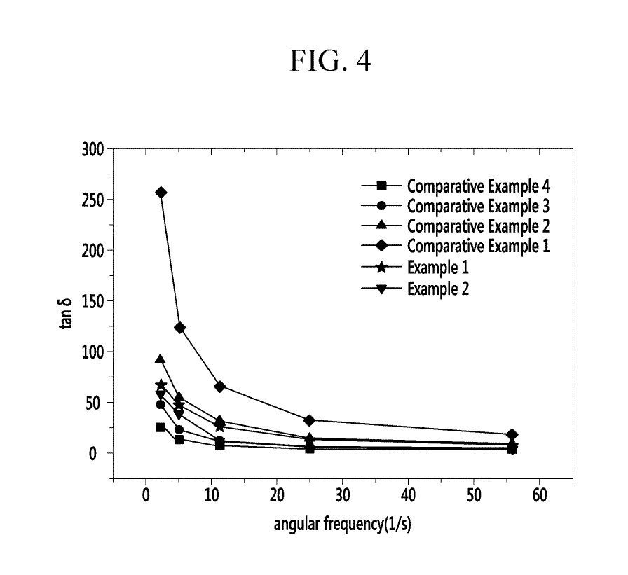

For the obtained coating composition, stress is measured using a rheometer in a frequency sweep mode at a strain of 1% to obtain tan δ. From the results, the tan δ values of the obtained compositions are shown in Table 1 and FIG. 4.

### Comparative Examples 1 to 4

### [1] Preparation of Coating Composition Including Poly(Amic Acid)

Under the nitrogen atmosphere, N-methyl-2-pyrrolidone (NMP) is introduced into a reactor. 2,2′-bis-trifluoromethyl-4,4′-biphenyldiamine (TFDB) is added to the reactor and dissolved to provide a TFDB solution. 3,3′,4,4′-biphenyltetracarboxylic dianhydride (BPDA) is added to the TFDB solution to provide a molar ratio with TFDB within 0.96 to 0.99 and reacted at 20° C. for 72 hours.

Using the obtained polyamic acid, the coating composition is prepared, but solid content is changed as below to provide compositions according to Comparative Examples 1 to 4.

Comparative Example 1: solid content of 10%,

Comparative Example 2: solid content of 11%,

Comparative Example 3: solid content of 13.4%, and

Comparative Example 4: solid content of 16%.

### [2] Measurement of Viscosity and Measurement of Tan δ

The obtained coating compositions are measured for viscosity using the same rheometer as in Example 1. From the results, it is confirmed that the composition of Comparative Example 1, the composition of Comparative Example 2, the composition of Comparative Example 3, and the composition of Comparative Example 4 have viscosity of 3460 cps, 6380 cps, 21,500 cps, and 51,800 cps, respectively.

For the obtained coating composition, tan δ is measured using the same rheometer as in Example 1 in accordance with the same procedure as in Example 1. The obtained compositions have tan δ as shown in Table 1 and FIG. 4.

### Example 2

### [1] Preparation of Coating Composition Including Poly(Amic Acid)

A coating composition including the same polyamic acid as in the comparative examples in a solid content of 12% is prepared.

### [2] Measurement of Viscosity and Measurement of Tan δ

The obtained coating compositions are measured for viscosity using the same rheometer as in Example 1. From the results, it is confirmed that the composition has viscosity of 9500 cps.

For the obtained coating composition, tan δ is measured using the same rheometer as in Example 1 in accordance with the same procedure and conditions as in Example 1.

The obtained compositions have tan δ as shown in Table 1 and FIG. 4.

### Example 3

### [1] Preparation of Coating Composition Including Poly(Amic Acid)

Under the nitrogen atmosphere, N-methyl-2-pyrrolidone (NMP) is introduced into a reactor. 2,2′-bis-trifluoromethyl-4,4′-biphenyldiamine (TFDB) is added into the reactor and dissolved to provide a TFDB solution. 3,3′,4,4′-biphenyltetracarboxylic dianhydride (BPDA) is added into the TFDB solution to provide a molar ratio with TFDB of less than or equal to about 0.95 and reacted at 20° C. for about 72 hours. According to the method, a coating composition including the polyamic acid in a solid content of 22% is prepared.

### [2] Measurement of Viscosity and Measurement of Tan δ

The obtained coating compositions are measured for viscosity using the same rheometer as in Example 1. From the results, it is confirmed that the composition has viscosity of 6000 cps.

For the obtained coating composition, tan δ is measured using the same rheometer as in Example 1 in accordance with the same procedure as in Example 1. The obtained compositions have tan δ shown in Table 1 and FIG. 4.

TABLE 1

| | | tan δ at each angular frequency | | | | |
|---|---|---|---|---|---|---|
| | Viscosity (cps) | 2.24 rad/s | 5.01 rad/s | 11.2 rad/s | 25.1 rad/s | 56.1 rad/s |
| Example 1 | 9820 | 67 | 47 | 25 | 12.5 | 6.3 |
| Example 2 | 9500 | 54.3 | 27.6 | 14.1 | 7.51 | 4.29 |
| Example 3 | 6000 | 18 | — | — | — | — |
| Comparative | 3460 | 257 | 124 | 65.1 | 31.4 | 17.3 |
| Example 1 | | | | | | |
| Comparative | 6380 | 92.4 | 55.1 | 29.5 | 14.1 | 7.63 |
| Example 2 | | | | | | |
| Comparative | 21,500 | 47 | 21.9 | 11.3 | 6.14 | 3.68 |
| Example 3 | | | | | | |
| Comparative | 51,800 | 24.9 | 12.6 | 6.72 | 3.93 | 2.54 |
| Example 4 | | | | | | |

As shown in Table 1, it is confirmed that the compositions according to Examples 1 to 3 have viscosity recommended for the slit coater used in the following coating property evaluation test and also have a maximum tan δ of less than 96 at an angle frequency of 2 to 10 s⁻¹. On the other hand, the compositions according to Comparative Examples 1 and 2 have viscosity recommended for the slit coater but have a maximum tan δ of greater than or equal to 96 at an angular frequency of 2 to 10 s⁻¹.

### Experimental Example 1

### Coating Properties of Compositions According to Examples 1 to 3

The compositions according to Examples 1 to 3 are charged in a nozzle of a slit coater (recommended viscosity: 5000 to 13,000 cps, slit width: 1 mm) and undergo slot extraction coating at a coating speed of 30 mm/s to provide a film having a thickness of 10 μm.

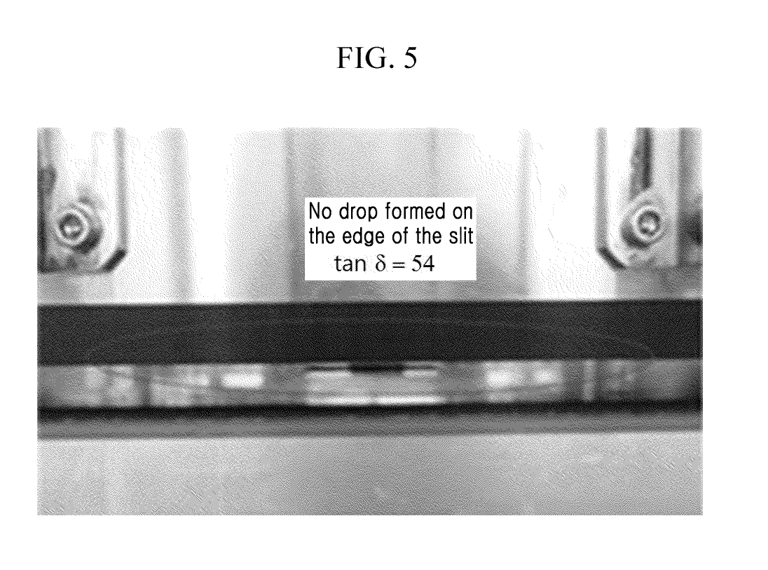

It is confirmed that the composition does not form drops in the coating lip on the slot extrusion coating with the composition. (Refer to FIG. 5, a coating lip part image during the slot extrusion coating with the composition according to Example 3)

### Experimental Example 2

### Coating Properties of Compositions According to Comparative Examples 1 to 4

The slot extraction coating is performed using the same slit coater as in Experimental Example 1 in accordance with the same procedure as in Experimental Example 1.

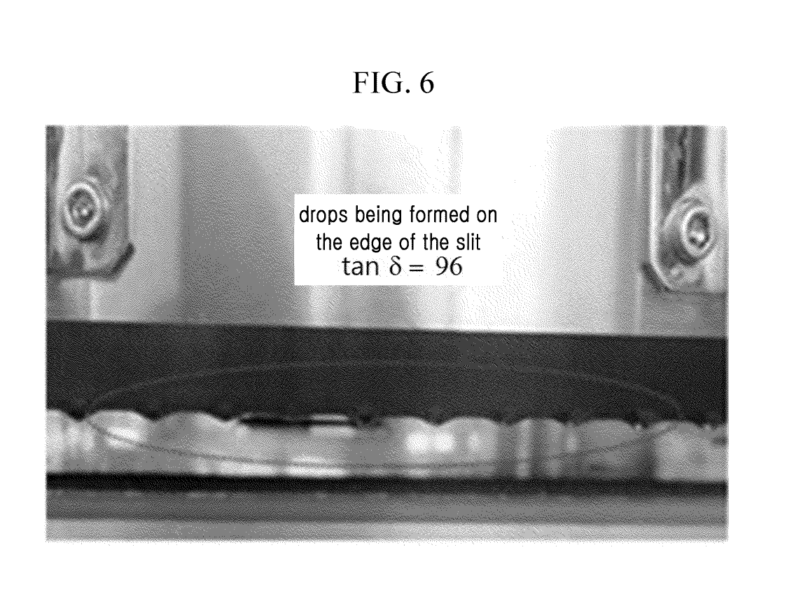

It is confirmed that the compositions according to Comparative Example 1 and Comparative Example 2 significantly form drops in the coating lip during the slot extrusion coating with the composition. (Refer to FIG. 6, a coating lip part image in the slot extraction coating with the composition according to Comparative Example 2)

It is confirmed that the compositions according to Comparative Example 3 and Comparative Example 4 having viscosity recommended for the slit coater may not undergo the coating.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A slot extrusion coating method comprising:
preparing a composition comprising a condensation polymerization product of a diamine and an acid dianhydride or a mixture of an acid dianhydride and a reactive carbonyl compound, an imidized product thereof, or a mixture thereof, wherein the composition has a viscoelasticity having a tan 15 of less than about 96 at a strain of about 1 percent and an angular frequency of more than about 0 to less than about 10 radians per second; and
coating the composition on a substrate with a slit coater.

2. The method of claim 1, wherein the substrate comprises a polymer, a metal oxide, a metal nitride, an organic/inorganic hybrid material, or a combination thereof.

3. The method of claim 1, wherein the acid dianhydride is represented by Chemical Formula 1, the diamine is represented by Chemical Formula 2, and the reactive carbonyl compound is represented by Chemical Formula 3: 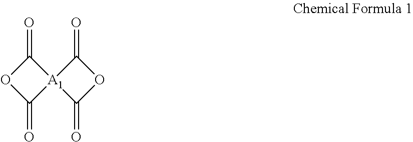
wherein A₁ is a substituted or unsubstituted tetravalent C6 to C24 aliphatic cyclic group, a substituted or unsubstituted tetravalent C6 to C24 aromatic cyclic group, or a substituted or unsubstituted tetravalent C4 to C24 heteroaromatic cyclic group, wherein the aliphatic cyclic group, the aromatic cyclic group, or the heteroaromatic cyclic group is present singularly, or two or more rings are fused to each other to provide a condensed ring; or two or more rings are linked through a direct bond, —O—, —S—, —C(═O)—, —CH(OH)—, —S(═O)₂—, —Si(CH₃)₂—, —(CH₂)ₚ— wherein 1≦p≦10, —(CF₂)_{q}— wherein 1≦q≦10, —CR₂— wherein each R is independently hydrogen, a C1 to C10 aliphatic hydrocarbon group, a C6 to C20 aromatic hydrocarbon group, or a C6 to C20 alicyclic hydrocarbon group, —C(CF₃)₂—, —C(CF₃)(C₅H₅)—, or —C(═O)NH—;
NH₂-A₂-NH₂ Chemical Formula 2
wherein A₂ is a substituted or unsubstituted divalent C6 to C24 aliphatic cyclic group, a substituted or unsubstituted divalent C6 to C24 aromatic cyclic group, or a substituted or unsubstituted divalent C4 to C24 heteroaromatic cyclic group, wherein the aliphatic cyclic group, the aromatic cyclic group, or the heteroaromatic cyclic group is present singularly, or two or more rings are fused to each other to provide a condensed ring; or two or more rings are linked through a direct bond, —O—, —S—, —C(═O)—, —CH(OH)—, —S(═O)₂—, —Si(CH₃)₂—, —(CH₂)ₚ— wherein 1≦p≦10, —(CF₂)_{q}— wherein 1≦q≦10, —CR₂— wherein each R is independently hydrogen, a C1 to C10 aliphatic hydrocarbon group, a C6 to C20 aromatic hydrocarbon group, or a C6 to C20 alicyclic hydrocarbon group, —C(CF₃)₂—, —C(CF₃)(C₆H₅)—, or —C(═O)NH—;
X—CO-A₃-CO—X Chemical Formula 3
wherein A₃ is a substituted or unsubstituted divalent phenylene moiety, a substituted or unsubstituted divalent naphthalene moiety, or a moiety wherein two substituted or unsubstituted aromatic rings are linked through a single bond, —O—, —S—, —C(═O)—, —SO₂—, —Si(CH₃)₂—, —(CR₂)ₚ— wherein 1≦p≦10, R is hydrogen, a hydroxy group, a C1 to C3 alkyl group, a C1 to C3 fluoroalkyl group, or —(CF₂)_{q}— wherein 1≦q≦10, and X is —Cl, —OH, or —OCH₃.

4. The method of claim 1, wherein the composition further comprises a viscoelasticity-controlling agent.

5. The method of claim 1, wherein the composition has a viscosity of about 1000 centipoise to about 20,000 centipoise.

6. The method of claim 4, wherein the viscoelasticity-controlling agent comprises silica particles, polymer beads, or a combination thereof.

7. The method of claim 1, wherein the preparing of the composition comprises adjusting the viscoelasticity of the composition by adjusting a solid content of the composition, a molecular weight, a polydispersity index, an amount of the condensation polymerization product or the imidized product thereof, a type of viscoelasticity-controlling agent, an amount of a viscoelasticity-controlling agent, or a combination thereof.

8. The method of claim 1, wherein the composition is selected to have tan δ of less than or equal to about 90 when measured by a rheometer at an angular frequency of greater than about 0 and less than about 10 radians per second.

9. The method of claim 1, wherein the composition is selected to have tan δ of less than or equal to about 75 when measured by a rheometer at an angular frequency of greater than about 0 to less than about 10 rad/s.
